(19) United States
(12) Patent Application Publication
(10) Pub. No.: US 2013/0065577 A1
(43) Pub. Date: Mar. 14, 2013

(54) ELECTRONIC SYSTEM FOR THE REMOTE MAINTENANCE OF A CRANE

(71) Applicants: Rossano CERESOLI, Ranica (BG) (IT); Roberto SIGNORI, Albino (BG) (IT); Giovanni FASSI, Bergamo (IT); Cristiano SPELTA, Bellusco (MB) (IT); Fabio PREVIDI, Milano (IT); Sergio Matteo SAVARESI, Cremona (IT)

(72) Inventors: Rossano CERESOLI, Ranica (BG) (IT); Roberto SIGNORI, Albino (BG) (IT); Giovanni FASSI, Bergamo (IT); Cristiano SPELTA, Bellusco (MB) (IT); Fabio PREVIDI, Milano (IT); Sergio Matteo SAVARESI, Cremona (IT)

(73) Assignee: FASSI GRU S.p.A, Albino (BG) (IT)

(21) Appl. No.: 13/614,379

(22) Filed: Sep. 13, 2012

(30) Foreign Application Priority Data
Sep. 14, 2011 (IT) MI2011A001648

(51) Int. Cl. H04W 4/00

(52) U.S. Cl. 455/419

(57) ABSTRACT

It is described an electronic system for the remote maintenance of a crane. The system comprises a computer configured to transmit over a telecommunications network a first request message carrying a remote command for the maintenance of the crane, said first request message being compliant to a medium/long distance radio-mobile protocol, comprises a mobile device configured to receive from the network the first request message and extract therefrom the remote maintenance command, configured to generate a second request message carrying the remote maintenance command, said second request message being compliant to a short distance wireless protocol, and comprises an electronic control unit configured to receive the second request message and extract therefrom the remote maintenance command, execute the remote maintenance command and send towards the computer a first answer message carrying information correlated to the remote maintenance command, said first answer message being compliant to the short distance wireless protocol.

### INCORPORATION BY REFERENCE OF PRIORITY DOCUMENT

This application is based on and claims the benefit of Italian Patent Application No. MI2011A001648 filed on Sep. 14, 2011, which is incorporated by reference herein.

### BACKGROUND

1. Technical Field

The present disclosure generally refers to the field of cranes. More in particular, the present disclosure concerns the remote maintenance of a crane.

2. Description of the Related Art

It is important to quickly identify and fix malfunctions or faults of a crane, in order to avoid accidents caused by malfunctions or faults.

For this reason the crane is provided with an electronic control unit, which comprises an interface for locally connecting the crane (for example, with a cable) to a personal computer, which is capable of modifying or re-programming the operating parameters of the crane.

Patent application EP 2168903 describes a device for the remote maintenance of a crane, by means of the use of second generation radio-mobile protocols, such as GSM and GPRS. This known solution has the disadvantage to be too complex and expensive, because it requires to implement in the crane a module compliant to the second generation protocols. Moreover, it has the disadvantage of requiring to modify the module in the crane in case of a change of the type of radio-mobile protocol.

### BRIEF SUMMARY

According to a first aspect, the present disclosure relates to an electronic system for the remote maintenance of a crane. The system comprises a computer configured to transmit over a telecommunications network a first request message carrying a remote command for the maintenance of the crane, said first request message being compliant to a medium/long distance radio-mobile protocol. The system further comprises a mobile device configured to receive from the telecommunications network the first request message and extract therefrom the remote maintenance command, configured to generate a second request message carrying the remote maintenance command, said second request message being compliant to a short distance wireless protocol. The system further comprises an electronic control unit configured to receive the second request message and extract therefrom the remote maintenance command, configured to execute the remote maintenance command and configured to send towards the computer a first answer message carrying information correlated to the remote maintenance command, said first answer message being compliant to the short distance wireless protocol.

The electronic system according to the present disclosure has the advantage to be simple to implement, to be cheap and not to depend on the type of radio-mobile protocol.

Preferably, the mobile device is further configured to generate a third request message carrying a local command for the maintenance of the crane, said third request message being compliant to the short distance wireless protocol. The electronic control unit is further configured to receive the third request message and extract therefrom the local maintenance command, is configured to execute the local maintenance command and is configured to send towards the mobile device a second answer message carrying information correlated to the local maintenance command, said second answer message being compliant to the short distance wireless protocol.

Preferably, the computer is configured to transmit the first request message in case of a fault or a severe malfunction of the crane, and the mobile device is configured to transmit the third request message in case of a less severe malfunction of the crane or a degradation of the performance of the crane.

Preferably, the short distance wireless protocol is Bluetooth® or IEEE 802.11 standard.

Preferably, the mobile device is a smartphone, in particular an iPhone®, a BlackBerry® or a Tablet, in particular an iPad.

Preferably, the medium/long distance radio-mobile protocol is a third generation protocol, in particular UMTS, HSDPA or HSUPA.

Preferably, the computer is a personal computer, a notebook, a netbook, a Tablet, in particular an iPad, a personal digital assistant, a pocket PC or a smartphone, in particular an iPhone®.

Preferably, the remote maintenance command carries a list of operating parameters of the crane and wherein the first answer message carries the actual values of the operating parameters.

According to a second aspect, the present disclosure relates to a method for performing the remote maintenance of a crane. The method includes step a) of transmitting from a computer over a telecommunications network a first request message carrying a remote command for the maintenance of the crane, said first request message being compliant to a medium/long distance radio-mobile protocol, includes step b) of receiving at a mobile device from the telecommunications network the first request message and extracting therefrom the remote maintenance command, includes step c) of generating at the mobile device a second request message carrying the remote maintenance command, said second request message being compliant to a short distance wireless protocol, includes step d) of receiving at an electronic control unit the second request message and extracting therefrom the remote maintenance command, includes step e) of executing at the electronic control unit the remote maintenance command, and includes step f) of sending from the electronic control unit towards the computer a first answer message carrying information correlated to the remote maintenance command, said first answer message being compliant to the short distance wireless protocol.

According to a third aspect, the present disclosure relates to a crane, in particular a loader crane. The crane comprises an electronic control unit configured to perform the step d) of receiving at the electronic control unit a second request message and extracting therefrom a remote maintenance command, the step e) of executing at the electronic control unit the remote maintenance command, and the step f) of sending from the electronic control unit towards the computer a first answer message carrying information correlated to the remote maintenance command, said first answer message being compliant to the short distance wireless protocol.

According to a fourth aspect, the present disclosure relates to a mobile device configured to perform the step b) of receiving at the mobile device from a telecommunications network a first request message and extracting therefrom a remote maintenance command, and the step c) of generating at the mobile device a second request message carrying the remote maintenance command, said second request message being compliant to a short distance wireless protocol.

### BRIEF DESCRIPTION OF THE SEVERAL VIEWS OF THE DRAWINGS

Further characteristics and advantages of the disclosure will result from the following description of a preferred embodiment and of its variants provided as an exemplary way with reference to the attached drawings, wherein:

FIG. 1 schematically shows an electronic system according to an embodiment of the disclosure.

### DETAILED DESCRIPTION

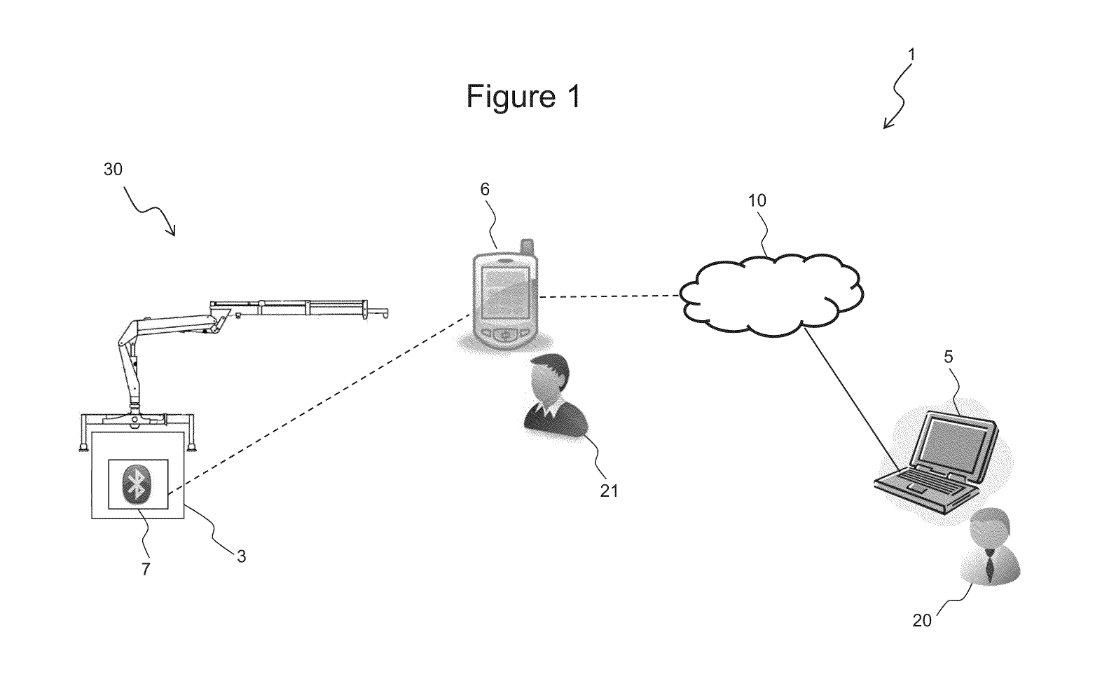

With reference to FIG. 1, it is shown an electronic system for the remote maintenance of a crane 30. The crane 30 can be placed on a fixed platform 3. Alternatively, the crane can be positioned on a mobile vehicle 3 (for example, on a trailer): in this case it is commonly known as “loader crane”.

The electronic system 1 comprises a computer 5, a mobile device 6 and an electronic control unit 7.

The computer 5 is for example a personal computer, a notebook, a netbook, a Tablet (for example, an iPad), a PDA (Personal Digital Assistant), a pocket PC or a smartphone (for example, an iPhone®). The computer 5 has the function to receive, from a remote maintenance worker 20, a remote command for the maintenance of crane 30 and to transmit over a telecommunications network 10 a first request message carrying the remote maintenance command, wherein a first request message is compliant to (that is, it fulfils) a medium/long distance radio-mobile protocol.

The telecommunications network 10 supports the medium/long distance radio-mobile protocol and carries the first request message from the computer 5 to the mobile device 6. The medium/long distance radio-mobile protocol is for example of third generation, in particular UMTS (Universal Mobile Telecommunications System), HSDPA (High-Speed Downlink Packet Access, or HSUPA (High-Speed Uplink Packet Access). Alternatively, the medium/long distance radio-mobile protocol can be of fourth generation, such as for example Lte (Long Term Evolution) and WiMax.

The mobile device 6 is for example a smartphone (for example, an iPhone®), a BlackBerry® or a Tablet (for example, an iPad®). The mobile device 6 has the function to receive from the telecommunications network 10 the first request message carrying the maintenance remote command and it has the function to generate a second request message carrying the maintenance remote command, wherein the second request message is compliant to a short-distance wireless (that is, radio) protocol, such as for example Bluetooth® or IEEE 802.11 standard.

The electronic control unit 7 has the function to receive from the mobile device 6 the second request message carrying the remote maintenance command, it has the function of executing the remote maintenance command and it has the function to transmit towards the computer 5 a first answer message carrying information correlated to the remote maintenance command. For example, the remote maintenance command indicates a list of operating parameters of the crane 30 (for example, the calibration values of the motors driving the arms of the crane 30) and the information carried by the first answer message is the list of the required operating parameters and the corresponding values of the operating parameters of the crane 30. Another example is the one wherein the remote maintenance command indicates the usage statistics of the crane 30 and the information carried by the first answer message are the values of said usage statistics.

Therefore in case of malfunctions or faults of the crane 30, the remote maintenance worker 20 is capable to understand (for example, from the received values of the operating parameters of the crane 30 or from the values of the usage statistics of the crane 30) the reason of the malfunction or fault and, preferably, is capable to intervene on the crane 30 for restoring the correct operation of the crane 30, by means of the maintenance commands transmitted by a station remote from the crane 30 and, preferably, by means of a subsequent modification of the values of the operating parameters of the crane 30 (for example, a modification of the calibration values of the motors), by exploiting the processing capability of the mobile device 6. This has the advantage of requiring a simple and cheap modification of the electronic control unit 7 of the crane 30, because it requires to implement a short-distance wireless protocol (for example, Bluetooth®) which is simple and does not require any maintenance, while the manufacturing complexity is concentrated on the mobile device 6 (typically, a smartphone), which can be find in the market and which is not excessively expensive due to its large scale sale. Therefore in case of a change of the technology of the radio-mobile network (for example, from one of the third generation to one of the fourth generation), it is not necessary to modify the electronic control unit 7 of crane 30, but it is sufficient to replace the mobile device 6 with another one implementing the new radio-mobile technology (in the example, the fourth generation), with the advantage that the new mobile device 6 is much less expensive than the modification of the electronic control unit 7 of the crane 30, because the mobile device 6 has a large scale spread.

Preferably, according to a second embodiment of the disclosure, the mobile device 6 is structured to receive from a local maintenance worker 21 a local maintenance command and it is structured to generate a third request message carrying the local maintenance command, wherein the third request message is compliant to a short-distance wireless protocol (for example, Bluetooth® or IEEE 802.11 standard). In this case, the electronic control unit 7 has the function to receive, from the mobile device 6, the third request message carrying the local maintenance command, to execute the local maintenance command and to transmit towards the computer 5 a second answer message carrying information correlated to the local maintenance command. In this way it is possible to use the local maintenance command for performing changes of the operating parameters of the crane 30 in case of minor malfunctions of the crane 30 or in case of an decrease of the performance of the crane 30 by using a poor-skilled local maintenance worker 21, while the remote maintenance commands are used for performing the modifications of the operating parameters of the crane 30 in case of faults of crane 30 or in case of serious malfunctions of the crane 30 by using a skilled remote maintenance worker 20. For example, the local maintenance worker 21 is the user using the crane 30, while the remote maintenance worker 20 is the manufacturer of the crane 30. Therefore in case of detection of a malfunction of the crane 30, first the local maintenance worker 21 queries the crane 30 by means of the local maintenance command and checks if the malfunction is serious. In a negative case, the local maintenance worker 21 is structured to modify the operating parameters of the crane 30 for fixing the not serious malfunction; in a positive case, the local maintenance worker 21 informs the remote maintenance worker 20 about the serious malfunction and thus the remote maintenance worker 20 is structured to transmit the remote maintenance command and is structured to modify the operating parameters of the crane 30 for fixing the serious malfunction. Afterwards, the local maintenance worker 21 is structured to verify the correct operation of the crane 30, by means of the transmission of a further maintenance local command.

It will be described hereinafter the operation of the electronic system 1 according to a first embodiment of the disclosure, referring also to FIG. 1.

For the purpose of explaining the operation it is supposed that the computer 5 is a personal computer executing a program structured to generate remote commands for the maintenance of crane 30 and structured to display on the screen of the computer 5 information correlated to said remote maintenance commands.

Moreover, it is supposed that the remote maintenance command carries a request of a parameters list describing the operation of the crane 30 and that the execution of the remote command consists in the operating parameters list and in the corresponding actual numerical values.

Moreover, it is supposed that the telecommunications network 10 uses the UMTS standard, that the mobile device 6 is a smartphone and that the smartphone exchanges information with the electronic control unit 7 by means of the Bluetooth® protocol.

At the starting instant t₀ the remote maintenance worker 20 detects a fault or a serious malfunction of the crane 30. The remote maintenance worker 20 sends a command to the personal computer 5, which executes a program generating a maintenance remote command carrying a request of a list of operating parameters of the crane 30. Afterwards, the personal computer 5 transmits to the UMTS telecommunications network 10 a first request message carrying the remote maintenance command indicating the request of the parameters list, wherein the first request message is compliant to UMTS protocol.

At instant t₁ (subsequent to instant t₀) the UMTS telecommunications network 10 receives the first request message and carries it from the personal computer 5 to the smartphone 6.

At instant t₂ (subsequent to instant t₁) the smartphone 6 receives from the UMTS telecommunications network 10 the first request message carrying the remote maintenance command indicating the request of the parameters list, extracts the remote maintenance command from the first request message and generates the second request message carrying the remote maintenance command, wherein the second request message is compliant to the Bluetooth® protocol.

At instant t₃ (subsequent to instant t₂) the electronic control unit 7 receives from the smartphone 6 the second request message carrying the remote maintenance command indicating the request of the parameters list, extracts the remote maintenance command from the second request message and executes the remote maintenance command, that is it provides the list of the operating parameters of the crane 30 and of the corresponding actual numerical values.

At instant t₄ (subsequent to instant t₃) the electronic control unit 7 transmits to the UMTS telecommunications network 10 the first answer message which is compliant to the Bluetooth® protocol, wherein the first answer message carries the operating parameters list of the crane 30 and the corresponding actual numerical values.

At instant t₅ (subsequent to instant t₄) the smartphone 6 receives from the electronic control unit 7 the first answer message carrying the operating parameters list of the crane 30 and the corresponding actual numerical values, extracts therefrom list of the operating parameters of the crane 30 and the corresponding actual numerical values and generates a second answer message carrying the list of the operating parameters of the crane 30 and of the corresponding actual numerical values, wherein the second answer message is compliant to the UMTS radio-mobile protocol.

At instant t₆ (subsequent to instant t₅) the UMTS telecommunications network 10 receives the second answer message and carries it from the smartphone 6 to the personal computer 5.

At instant t₇ (subsequent to instant t₆) the personal computer 5 receives the second answer message carrying the list of the operating parameters of the crane 30 and of the corresponding actual numerical values, extracts from the second answer message the list of the operating parameters of the crane 30 and the corresponding actual numerical values and displays them on the screen of the personal computer 5.

At instant t₈ (subsequent to instant t₇) the remote maintenance worker 20 reads out the information displayed on the screen, analyses it and identifies the type of fault or serious malfunction of the crane 30.

According to a first variant of the first embodiment of the disclosure, at instant t₈ the remote maintenance worker 20 reads out the information displayed on the screen, analyses it, identifies the type of fault or serious malfunction of crane 30 and further calculates the modified values of one or more operating parameters of the crane 30, in order to fix the serious malfunction of the crane 30.

At instant t₉ (subsequent to instant t₈) the remote maintenance worker 20 sends a command to the personal computer 5, which executes the program generating a first configuration message indicating one or more operating parameters and the corresponding modified values. Afterwards, the personal computer 5 transmits to the UMTS telecommunications network 10 the first configuration message carrying said one or more operating parameters and the corresponding modified values.

At instant t₁₀ (subsequent to instant t₉) the UMTS telecommunications network 10 receives the first configuration message and carries it from the personal computer 5 to the smartphone 6.

At instant t₁₁ (subsequent to instant t₁₀) the smartphone 6 receives from the UMTS telecommunications network 10 the first configuration message, extracts therefrom said one or more operating parameters and the corresponding modified values and generates a second configuration message carrying said one or more operating parameters and the corresponding modified values, wherein the second configuration message is compliant to the Bluetooth® protocol.

At instant t₁₂ (subsequent to instant t₁₁) the electronic control unit 7 receives from the smartphone 6 the second configuration message, extracts therefrom said one or more operating parameters and the corresponding modified values and modifies the values of said one or more operating parameters, modifying in this way the operation of the crane 30 (for example, by modifying the calibration values of motors driving the arms of the crane 30). In this way, the serious malfunction of the crane 30 has been fixed by means of the remote maintenance worker 20.

It will be described hereinafter the operation of the electronic system 1 according to a second embodiment of the disclosure, referring also to FIG. 1.

According to the second embodiment, the local maintenance worker 21 sends commands towards the crane 30 in a time interval t₀′ . . . t₄′ preceding the instant t₀ at which the remote maintenance worker 20 sends the commands towards the crane 30.

At instant t₀′ the local maintenance worker 21 detects a malfunction of the crane 30 and sends a command to the smartphone 6, which executes a program generating a local maintenance command carrying a request of a list of operating parameters of the crane 30. Afterwards, the smartphone 6 generates a third request message carrying the local maintenance command indicating the request of the list of the operating parameters, wherein the third request message is compliant to the Bluetooth® protocol.

At instant t₁′ (subsequent to instant t₀′) the control electronic unit 7 receives from the smartphone 6 the third request message carrying the local maintenance command indicating the request of the parameters list, extracts the local maintenance command from the third request message and executes the local maintenance command, that is it provides the list of the operating parameters of the crane 30 and of the corresponding actual values.

At instant t₂′ (subsequent to instant t₁′) the electronic control unit 7 transmits a third answer message which is compliant to the Bluetooth® protocol, wherein the third answer message carries the list of the operating parameters of the crane 30 and of the corresponding actual numerical values.

At instant t₃′ (subsequent to instant t₂′) the smartphone 6 receives from the electronic control unit 7 a third answer message carrying the list 0 of the operating parameters of the crane 3 and of the corresponding actual numerical values, extracts from the third answer message the list of the operating parameters of the crane 30 and of the corresponding actual numerical values and displays them on screen of the smartphone 6.

At instant t₄′ (subsequent to instant t₃′) the local maintenance worker 21 reads out the information displayed on the screen of the smartphone 6, analyses them and detects that it occurred a fault (or a serious malfunction) of the crane 30, then it informs the remote maintenance worker 20 about the fault (or serious malfunction) of the crane 30.

The operation continues with the instants t₀′ . . . t₂′ previously described, wherein the remote maintenance worker 20 intervenes.

According to a variant of the second embodiment of the disclosure, the local maintenance worker 21 sends the local commands to the crane 30 in a time interval t₀′, t₁′, t₂′, t₃′, t₄″, t₅″ preceding the instant t₀ at which the remote maintenance worker 20 sends the remote commands towards the crane 30.

The operation at instants t₀′ . . . t₃′ is the same as the one previously described at instants t₀′ . . . t₃′ regarding the second embodiment of the disclosure.

At instant t₄″ (subsequent to instant t₃′) the local maintenance worker 21 reads out the information displayed on the screen of the smartphone 6, analyses them, identifies that it is a minor malfunction of the crane 30 and calculates the modified values of one or more operating parameters of the crane 30. Afterwards, the local maintenance worker 21 sends a command to the smartphone 6, which executes the program generating a third configuration message indicating one or more operating parameters and the corresponding modified values, wherein the third configuration message is compliant to the Bluetooth® protocol.

At instant t₅″ (subsequent to instant t₄″) the electronic control unit 7 receives from the smartphone 6 the third configuration message, extracts therefrom said one or more operating parameters and the corresponding modified values and modifies the values of said one or more operating parameters, thus modifying the operation of the crane 30. In this way the minor malfunction of the crane 30 has been fixed by means of the local maintenance worker 21, thus avoiding the intervention of the remote maintenance worker 20.

According to a second aspect, the present disclosure relates to a method of performing the remote maintenance of a crane, in particular a loader crane. The method comprises the following steps:
a) transmitting from a computer over a telecommunications network a first request message carrying a remote command for the maintenance of the crane, said first request message being compliant to a medium/long distance radio-mobile protocol;
b) receiving at a mobile device from the telecommunications network the first request message and extracting therefrom the remote maintenance command;
c) generating at the mobile device a second request message carrying the remote maintenance command, said second request message being compliant to a short distance wireless protocol;
d) receiving at an electronic control unit the second request message and extracting therefrom the remote maintenance command;
e) executing at the electronic control unit the remote maintenance command;
f) sending from the electronic control unit towards the computer a first answer message carrying information correlated to the remote maintenance command, said first answer message being compliant to the short distance wireless protocol.

Preferably, the method for the remote maintenance of the crane 30 further comprises the following steps:
generating a third request message carrying a local command for the maintenance of crane, said third request message being compliant to the short-distance wireless protocol;
receiving the third request message and extracting therefrom the local maintenance command;
executing the local maintenance command;
sending a second answer message carrying information correlated to the local maintenance command, said second answer message being compliant to the short-distance wireless protocol.

The electronic control unit 7 is configured to execute the steps d), e), f) of the method according to the second aspect for the remote maintenance of the crane 30.

The mobile device 6 is configured to execute the steps b), c) of the method according to the second aspect for the remote maintenance of the crane 30.

1. Electronic system for the remote maintenance of a crane, the system comprising:
a computer configured to:
transmit over a telecommunications network a first request message carrying a remote command for the maintenance of the crane, said first request message being compliant to a medium/long distance radio-mobile protocol;
a mobile device configured to:
receive from the telecommunications network the first request message and extract therefrom the remote maintenance command;
generate a second request message carrying the remote maintenance command, said second request message being compliant to a short distance wireless protocol;
an electronic control unit configured to:
receive the second request message and extract therefrom the remote maintenance command;
execute the remote maintenance command;
send towards the computer a first answer message carrying information correlated to the remote maintenance command, said first answer message being compliant to the short distance wireless protocol.

2. Electronic system according to claim 1, wherein the mobile device is further configured to:
generate a third request message carrying a local command for the maintenance of the crane, said third request message being compliant to the short distance wireless protocol,
and wherein the electronic control unit is further configured to:
receive the third request message and extract therefrom the local maintenance command;
execute the local maintenance command;
send towards the mobile device a second answer message carrying information correlated to the local maintenance command, said second answer message being compliant to the short distance wireless protocol.

3. Electronic system according to claim 2, wherein the computer is configured to transmit the first request message in case of a fault or a severe malfunction of the crane, and wherein the mobile device is configured to transmit the third request message in case of a less severe malfunction of the crane or a degradation of the performance of the crane.

4. Electronic system according to claim 1, wherein the short distance wireless protocol is Bluetooth® or IEEE 802.11 standard.

5. Electronic system according to claim 1, wherein the mobile device is a smartphone, in particular an iPhone®, a BlackBerry® or a Tablet, in particular an iPad.

6. Electronic system according to claim 1, wherein the medium/long distance radio-mobile protocol is a third generation protocol, in particular UMTS, HSDPA or HSUPA.

7. Electronic system according to claim 1, wherein the computer is a personal computer, a notebook, a netbook, a Tablet, in particular an iPad, a personal digital assistant, a pocket PC or a smartphone, in particular an iPhone®.

8. Electronic system according to claim 1, wherein the remote maintenance command carries a list of operating parameters of the crane and wherein the first answer message carries the actual values of the operating parameters.

9. Method for performing the remote maintenance of a crane, the method comprising the steps of:
a) transmitting from a computer over a telecommunications network a first request message carrying a remote command for the maintenance of the crane, said first request message being compliant to a medium/long distance radio-mobile protocol;
b) receiving at a mobile device from the telecommunications network the first request message and extracting therefrom the remote maintenance command;
c) generating at the mobile device a second request message carrying the remote maintenance command, said second request message being compliant to a short distance wireless protocol;
d) receiving at an electronic control unit the second request message and extracting therefrom the remote maintenance command;
e) executing at the electronic control unit the remote maintenance command;
f) sending from the electronic control unit towards the computer a first answer message carrying information correlated to the remote maintenance command, said first answer message being compliant to the short distance wireless protocol.

10. Crane, in particular a loader crane, comprising an electronic control unit configured to perform the steps of:
d) receiving at the electronic control unit a second request message and extracting therefrom a remote maintenance command;
e) executing at the electronic control unit the remote maintenance command;
f) sending from the electronic control unit towards the computer a first answer message carrying information correlated to the remote maintenance command, said first answer message being compliant to the short distance wireless protocol.

11. A mobile device configured to perform the steps of:
receiving at the mobile device from a telecommunications network a first request message and extracting therefrom a remote maintenance command; and
generating at the mobile device a second request message carrying the remote maintenance command, said second request message being compliant to a short distance wireless protocol.
